(19) United States
(12) Patent Application Publication
(10) Pub. No.: US 2009/0309021 A1
(43) Pub. Date: Dec. 17, 2009

(54) Ion detection method and apparatus with scanning electron beam

(75) Inventors: Armin Schon, Nes-Ziona (IL); Eli Cheifetz, Ramat-Gan (IL); Alexander Berezin, Ashdod (IL); Oren Zarchin, Raanana (IL)

Correspondence Address: BACON & THOMAS, PLLC, 625 SLATERS LANE, FOURTH FLOOR, ALEXANDRIA, VA, 22314-1176, US

(73) Assignee: El-Mul Technologies Ltd., Yavne (IL)

(21) Appl. No.: 12/213,285

(22) Filed: Jun. 17, 2008

(51) Int. Cl. G01N 23/00

(52) U.S. Cl. 250/306; 250/310

(57) ABSTRACT

The invention pertains to a method for imaging a sample by detecting ions emitted from said sample, wherein
the emission of the ions to be detected is caused by a scanning particle beam impacting on said sample;
and wherein detecting of the ions comprises
collecting the ions; converting the collected ions to electrons and detecting the converted electrons by means of an electron detector;
characterized in that
the particle beam is an electron beam.

### FIELD OF THE INVENTION

The present invention relates to a method and an apparatus for imaging a sample by detecting ions and, optionally, electrons emitted from said sample, wherein the emission of the particles to be detected is caused by a scanning beam impacting on said sample.

### BACKGROUND OF THE INVENTION

Scanning beam imaging apparatuses generally comprise scanning electron beams and scanning ion beams, also referred to as focused ion beams (FIB). Scanning Electron Microscopes (SEM) and Focused Ion Beam (FIB) instruments are used for micro-scale and nano-scale materials characterization and surface modification, respectively. Formation of microstructures by FIB instruments is well established in nanotechnology for electronic devices fabrication, e.g. etching, ion implantation, materials nano-scale deposition, etc., mask repair, samples preparation for TEM, etc. Moreover, complex systems combining SEM/FIB methods in a single integrated device are available and referred to, inter alia, as dual beam, or crossbeam devices. The latter devices allow an extended range of applications, such as precision processing of materials in the nano-scale under SEM control and correction.

Image formation in an SEM is based on the acquisition of signals that originate from the interaction of the primary electron beam striking a specimen to be imaged. The most widely utilized signal produced by the interaction of the primary focused electron beam with the sample is the Secondary Electron (SE) emission signal.

Another type of the signal is a Backscattered Electron (BSE) signal.

Detection and measurement of the electron signal in SEMs generally is implemented by the following way: First—the secondary electrons that are emitted from a specimen are directed towards a SE detector by an electrical field, which is generated by a sparse collecting grid for the purpose of most possible electron collection; Second—collected secondary electrons are transformed within to photons by interaction with a scintillating material and produce a light signal that is proportional to the quantity of the collected secondary electrons; Third—the photons of the derived light signal are conveyed within light guide to a light detection device (Photo Multiplication Tubes—PMT which can be either in the vacuum chamber or external to it), which transforms the light signal to electric current and amplifies it. The electronic devices read this current signal and form the image of investigated specimen. The detected number of SE produced by the scanning primary beam striking the specimen, at every point, provides the imaging of the surface topography. In an alternative detection scheme, the collected secondary electrons are amplified and transformed to electric current by a Multi-Channel Plate (MCP).

FIB systems use a scanning ion beam accelerated by 10-30 kV voltage. FIB can operate at as low ion beam currents as 6-10 pA for imaging, or three orders higher beam currents, about 10 nA for precision submicron removing surface materials by sputtering or nano-scale milling.

Primary ion beam impinges on the specimen and sputters a small amount of material. The particles that are emitted from the surface layer are positive or negative secondary ions, neutral atoms and secondary electrons. Secondary electron detection is performed as described before. Secondary ion detection requires collection of the emitted secondary ions, conversion of collected secondary ions to electrons, collection and detection of the electrons by transformation to photons as described before.

Ion and electron beam operation with insulating specimen (such as SiO2 etc.) is affected by charging of the specimen surface, which causes variability in secondary electron emission. A charge control and compensation is required to avoid this charging effect. For this purpose, additional components and devices must be used with a SEM or a FIB system, such as a low-energy electron flood gun or variable pressure gas environment to provide charge neutralization. It significantly complicates the operation of the imaging devices and raises their prices.

In view of the above, it is an object of the present invention to provide a method and an apparatus for imaging surfaces that overcome the above shortcomings. The object is solved by the method according to claim 1 and the apparatus according to claim 5.

### SUMMARY OF THE INVENTION

The invention provides a method for imaging a sample by detecting ions emitted from said sample, wherein

the emission of the ions to be detected is caused by a scanning particle beam impacting on said sample;
and wherein detecting of the ions comprises
collecting the ions; converting the collected ions to electrons and detecting the converted electrons by means of an electron detector;
wherein further
the particle beam is an electron beam.

According to a first aspect of the method according to the invention the detected ions are positive ions and, the ions are collected by applying a negative bias to a sparse grid with respect to the potential of the sample.

According to a second aspect of the method according to the invention the energy of the electron beam is selected such that the ions emitted from the sample are physically produced by electrons ionizing adsorbed molecules that reside on the sample. To this end, the energy of the electron beam is, for example, not more than 5 kV, preferably not more than 3 keV, and more preferred not more than 1 keV. The lower limit of the electron energy is preferably not less than 50 eV, more preferred not less than 100 eV.

To appreciate this point, it should be considered that each sample generally has physically adsorbed and chemisorbed molecules on its surface, which occupy high-energy binding sites and unsaturated binds of the surface. The binding energy of the physically adsorbed molecules is determined by the weak Van der Waals forces and lies in range of 8-30 kJ/mol that is equal to 0.08-0.3 eV. The binding energy of the chemisorbed atoms is in range of 80-900 kJ/mol, or 0.8-9 eV. Thermal desorption requires a high temperature and is minimal at room temperature of about 300 K. The energy equivalent of this temperature E=kT is near 0.025 eV.

When low-energy primary electron beam of 5 kV or down to 0.1 kV strikes a specimen surface, it both generates secondary electrons and simultaneously ionizes molecules that were physically adsorbed and/or chemisorbed by the specimen surface. Some of these ions are released from the surface of the specimen. In order to derive Secondary Ion imaging under the scanning electron beam mode operation, the sparse collecting grid is biased by negative voltage of −2.5 kV to attract these released positive ions and at the same time to repel secondary electrons generated by the primary electron beam, which have energy below 50 eV. Ion-to-electron converter that is placed behind sparse grid is biased by negative voltage of −3.5 kV to accelerate the collected positive ions and being struck by these ions generates the secondary electrons.

The SEs are accelerated towards the scintillating plate by the high negative voltage of −10 kV that applied to scintillator. Further light signal generation, conveying, amplification and readout is similar to the one described above.

This unique new type of Ion Imaging is applicable in SEM and SEM/FIB instruments as well as in Secondary Ion Mass Spectroscopy (SIMS) systems and provides large-scale ability for nano-technologies further improvement.

According to a third aspect of the invention, a sparse collecting grid is biased by negative voltage of not less than −BG kV, wherein BG is not less than 1.5 preferably not less than 2.0 and more preferred not less than about 2.3 to attract the released positive ions and at the same time to repel electrons generated by primary electron beam. As BG increases more ions will be attracted toward the detector. However, a value too high can cause breakdowns between the collecting grid, a grounding shield or the converter. BG can even be higher than 3.0 as long as this limit is taken into account. According to a fourth aspect of the invention an ion-to-electron converter is provided behind sparse grid, and wherein the ion-to-electron converter is biased to more negative values than to collecting grid, for example, by negative voltage of −3.5 kV to accelerate the collected positive ions towards the ion-to electron converter. Electrons released by the ion-to-electron-converter are accelerated toward a scintillating plate, which is biased preferably in range of +2 kV up +10 kV, in order to generate photons upon impact of said electrons. The photons are detected subsequently by a photo-multiplier-tube.

The method according to the present invention is particularly suitable for imaging samples comprising electrically insulating materials or layers, since the effect of charging is reduced.

According to a still further aspect of the method of the invention a sample may be imaged, by detecting different types of particles emitted or backscattered from said sample, wherein the emission or scattering of said particles to be detected is caused by scanning particle beam impacting on said sample in different modes of operation, wherein a first mode of operation comprises imaging ions emitted upon impact of an electron beam and at least one further mode of operation comprises detecting electrons emitted from the sample upon impact of a scanning electron beam or a scanning ion beam and/or detecting ions emitted from the sample upon impact of a scanning ion beam. The sample is preferably maintained at the same sample position during the imaging in the different imaging modes. By means of this operation in different modes, a plurality of images from the same sample can be obtained, wherein the respective contrast mechanism of each of said images is different and, thereby provides additional information.

For example, at least one further mode of operation comprises detecting electrons emitted from the sample upon impact of a scanning electron beam, or at least one further mode of operation comprises detecting electrons backscattered from the sample upon impact of a scanning electron beam.

To further illustrate this point, imaging based on detection of electrons, scattered or emitted upon impact of a scanning electron beam is dependent on the type of electrons that are collected from the sample upon impact of scanning electron beam. A secondary electron is produced when an electron from the primary focused scanning electron beam accelerated by high voltage of e.g. 6-10 kV collides with an electron from a specimen atom and loses energy to it, thereby causing the emission of a secondary electron. Secondary electrons typically have energies of less than 50 eV. The resulting image has a spatial resolution of down to 1 nm and gives detailed topographical information. It is provided by a large number of secondary electrons that are emitted from a small region around the point of impact.

Another type of the signal originates from backscattered electrons, which are created by elastic collisions between the primary beam electrons and the nuclei of the specimen atoms. These collisions result in the primary electrons bouncing off from the larger, more massive nuclei. Backscattered electrons usually have energy from 50 eV up to primary beam energy. The number of backscattered electrons produced increases with the atomic number of the specimen increasing. For this reason a sample that is composed of two or more different elements, which differ significantly in their atomic numbers, will produce an image that shows differential contrast of the elements despite a uniform topography. Elements that are of a higher atomic number will produce more backscattered electrons and will therefore appear brighter than neighbouring lower atomic number elements. However, the spatial resolution of an image based on backscattered electrons is about 0.1 μm, which is considerably less than this one for SE image.

Using a variably biased sparse collecting grid the motion of the low-energy secondary electrons (SE) can be controlled. A positive voltage on the sparse collecting grid attracts the SE to the detector. Images obtained in this “SE mode” of operation show extremely high edge definition and emphasize the small detail on the surface of the samples. On the other hand, applying a negative 50-80 V bias to the sparse collecting grid will cause SEs to be repelled from the detector. Images acquired in this “BSE mode” are derived from backscattered signal only, as the high-energy BSEs are unaffected by the small negative bias on the collecting grid and strike the detector anyway. Since BSEs move in line-of-sight paths, the shadows caused by high areas blocking BSEs from lower areas are much accentuated, emphasizing the overall topography of the sample surface.

According to yet another aspect of the method of the invention one of said further imaging modes may comprise detecting electrons or ions emitted from the sample upon impact of a scanning ion beam, also referred to as focussed ion beam (FIB).

Said method may comprise an ion beam accelerated by 10-30 kV impacting the sample, wherein the particles that are emitted from the surface layer of a sample are positive or negative secondary ions, neutral atoms and secondary electrons. A primary ion beam provides two FIB imaging modes, secondary electron (SE) imaging and secondary ion (SI) imaging. The signal formed by the secondary ions or secondary electrons is collected to form an image by scanning the specimen surface selected site.

In order to optimize for spatial resolution, SE imaging is preferred in FIB mode operation. For this purpose the detector sparse collecting grid is positively biased for example by 0.5-1.0 kV voltage, and the collected electrons are accelerated towards a scintillating plate which is positively biased up to 10 kV.

In order to optimize for deep sample penetration, SI imaging is preferred in FIB mode operation. For this purpose the detector sparse collecting grid is negatively biased by a voltage of −BG kV, wherein BG is preferably between 1.5 and 3.7 voltage, an ion to electron converter is biased, e.g. at −3.5-−5 kV voltage, never more positive than the collector grid, and scintillating plate is positively biased, e.g. at 10 kV voltage, to accelerate emitted from converter electrons.

The invention further discloses an apparatus for imaging a sample by detecting ions emitted from said sample, especially according to the method of the invention, the apparatus comprising:

a scanning particle beam source for impacting on a sample for causing the emission of ions to be detected;
a detector for detecting said ions, wherein said detector comprises
a collector, said collector being biasable for collecting the ions;
an ion to electron converter for converting the collected ions to electrons; and
an electron detector for detecting the electrons released by the ion to electron converter;
wherein said particle beam source is an electron beam source.

According to a further aspect of the invention the apparatus is an apparatus for imaging a sample by selectably detecting either electrons or detecting ions emitted from said sample, the apparatus comprising:

a scanning particle beam source for impacting on a sample for causing the emission of ions or electrons to be detected;
a detector for selectably detecting said ions or electrons, wherein said detector comprises
a collector, especially a collector grid, said collector being biasable for collecting the ions or said electrons;
an ion to electron converter for converting the collected ions to electrons; and
an electron detector for detecting electrons wherein the electrons are, as the case may be, electrons emitted from the sample or electrons emitted from the converter;
wherein said particle beam source is an electron beam source.

According to a further aspect of the invention electrons originating from the sample are made to impact the converter surface, thereby increasing the number of electrons to be detected by the electron detector.

According to a further aspect of the invention a first bias voltage which is applied to the collector and a second bias voltage which is applied to the converter surface are set in a fixed bias ratio.

According to a further aspect of the invention, the apparatus comprises control means arranged to control the electron beam source to provide said scanning electron beam and arranged to control the detector to detect ions.

An embodiment of the invention is discussed with reference to the drawings. It shows:

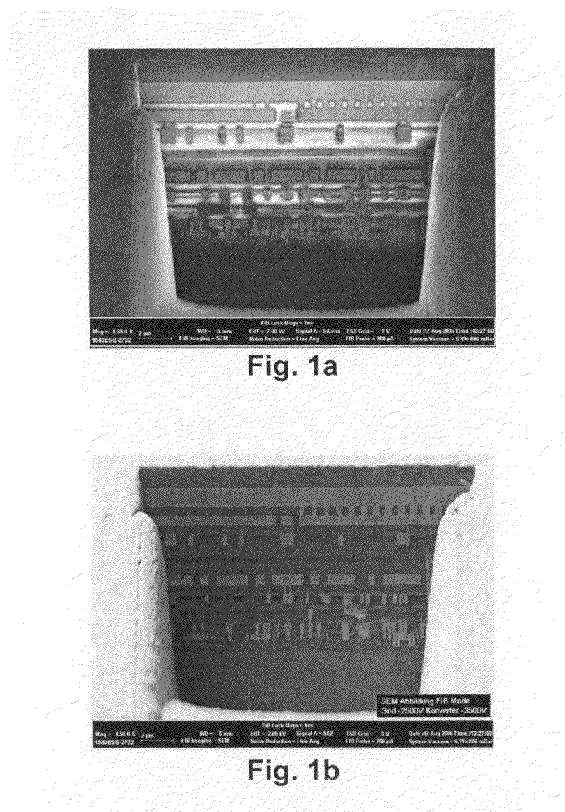

FIG. 1a: a secondary electron image of a sample generated by a SEM-Electron-Beam and detected by an in-lens electron-detector;

FIG. 1b: a secondary ion image of the sample in FIG. 1a generated by a SEM-Electron-Beam and detected by an ion detector set up to ion mode with a grid voltage at −2500V, to convert the ions to electrons with the converter voltage at −3500V and to convert these electrons to a signal with a scintillator and PMT.

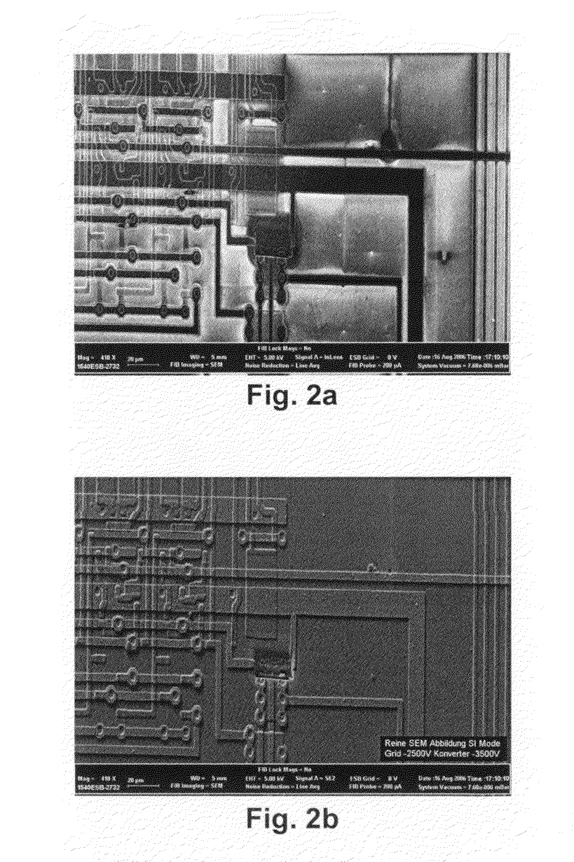

FIG. 2a: a secondary electron image of a sample generated by a SEM-Electron-Beam and detected by an in-lens electron-detector;

FIG. 2b: a secondary ion image of the sample in FIG. 2a, generated by a SEM-Electron-Beam set up to ion mode with a grid voltage at −2500V, to convert the ions to electrons with the converter voltage at −3500V and to convert these electrons to a signal with a scintillator and PMT.

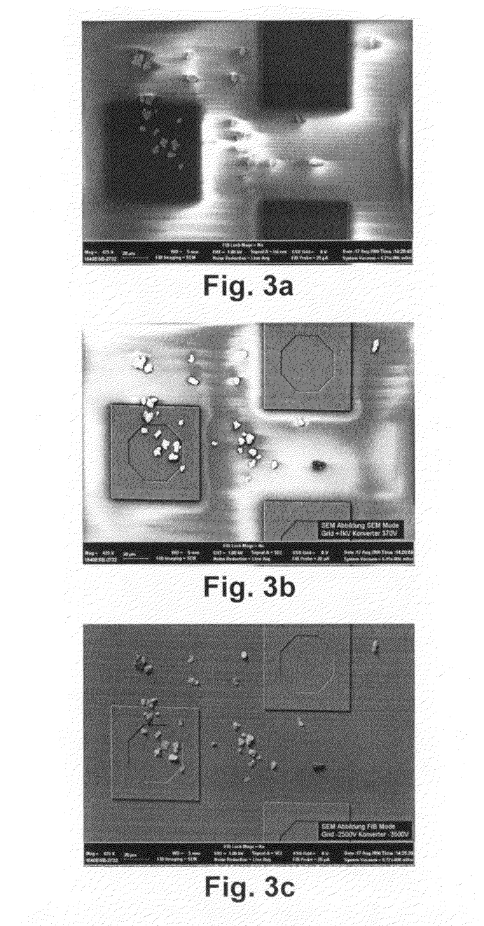

FIG. 3a: a secondary electron image of a sample generated by a SEM-Electron-Beam and detected by an in-lens electron-detector;

FIG. 3b: a secondary electron image of the sample in FIG. 3a collected by an ion detector in secondary electron mode set up to attract electrons with a grid voltage of 1 kV; and

FIG. 3c: an ion image of the sample in FIG. 3a generated by a SEM-Electron-Beam and detected by an ion detector set up to ion mode with a grid voltage at −2500V, to convert the ions to electrons with the converter voltage at −3500V and to convert these electrons to a signal with a scintillator and PMT.

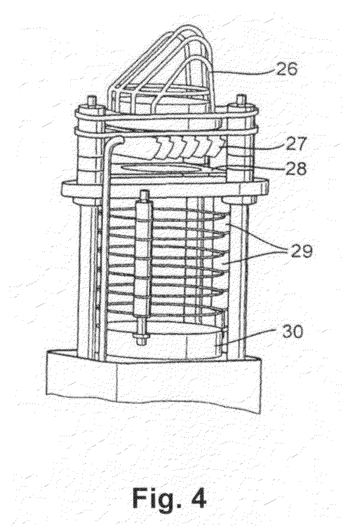

FIG. 4: a particle detector suitable for performing the method according to the present invention.

FIGS. 1a and 1b provide a first comparison between the imaging in accordance with the present invention and imaging in accordance with the prior art. FIG. 1a shows a secondary electron image of a sample generated by a SEM-Electron-Beam and detected by an in-lens electron-detector, while FIG. 1 b shows a secondary ion image of the sample in FIG. 1a generated by a SEM-Electron-Beam and detected by an ion detector in set up to ion mode—to attract ions with a grid voltage at −2500V, to convert the ions to electrons with the converter voltage at −3500V and to convert these electrons to a signal with a scintillator and PMT. Clearly, the images are based on different contrast mechanisms and, therefore, provide different information. The secondary electron image in FIG. 1a provides topographic information which, however, is subjected to charging effects. By contrast the ion image in FIG. 1b is not impaired by charging and provides excellent material contrast based on physically adsorbed or chemisorbed species.

Similar effects are presented in a comparison between FIGS. 2a and 2b. The secondary electron image provides great topographical detail, however, it is, again, impaired by charging, while the ions released upon impact of the scanning electron beam result in a clear image of the surface layer of the sample shown in FIG. 2a, wherein the image does not indicate any charging effects.

A third series of images shows a comparison between different electron imaging modes and an ion imaging mode, wherein all images originate from a scanning electron beam. The sample comprises flake-like contaminants of a silver paste on a surface. These contaminants are visible in all imaging modes, however, the susceptibility to charging is not a problem for the ion detection mode.

In conclusion, the method in accordance to the present invention provides an additional approach to sample imaging, which provides complementary information and is not impaired by charging effects. This new type of imaging provides the highest materials and structure contrast and does not need any charge control devices.

FIG. 4 shows a detector which is suitable for implementing the method of the invention. Details of the detector are described in international publication WO/2006/120005. The detector comprises a collector grid 26 followed by a Venetian blind type ion-to-electron converter 27, a further control electrode 28, to repel undesired particles, and ring electrodes 29 which confine the trajectories of electrons between the ion-to-electron converter and the electron detector, wherein the latter comprises a scintillator 30. Further details regarding the detector are disclosed in WO/2006/120005, which is incorporated by reference. By applying the appropriate voltages to the collector and to the ion-to-electron converter, respectively, either electrons are collected and detected by impacting the scintillator 30 without contacting the surfaces of the ion-to-electron converter, or (positive) ions are collected, and are made to impact on to the surfaces of the ion-to-electron converter and the emitted electrons are detected as discussed before.

1. A method for imaging a sample by detecting ions emitted from said sample, wherein the emission of the ions to be detected is caused by a scanning particle beam impacting on said sample; and
wherein detecting of the ions comprises collecting the ions; converting the collected ions to electrons and detecting the converted electrons by means of an electron detector; characterized in that the particle beam is an electron beam.

2. The method of claim 1, wherein the detected ions are positive ions, and, wherein the ions are collected by applying a negative bias to a sparse grid with respect to the potential of the sample.

3. The method of claim 1, wherein the energy of the electron beam is selected such that the ions emitted from the sample are physically adsorbed ions and/or ions.

4. The method of claim 3, wherein the energy of the electron beam is not more than 1 kV, preferably not more than 0.5 keV, and more preferred not more than 0.25 keV.

5. The method of claim 3, wherein the energy of the electron beam is not less than 50 eV, preferably not less than 100 eV.

6. The method of claim 3, wherein a sparse collecting grid is biased by negative voltage of not less than −BG kV, wherein BG is not less than 1.5, preferably not less than 2.0 and more preferred not less than about 2.3 to attract the released positive ions and at the same time to repel generated by primary electron beam.

7. The method of claim 1, wherein an ion-to-electron converter is provided behind sparse grid, and wherein the ion-to-electron converter is biased by negative voltage, more negative than the collecting grid voltage, to accelerate the collected positive ions towards the ion-to electron converter.

8. The method of claim 7, wherein electrons released by the ion-to-electron-converter are accelerated toward a scintillating plate, which is biased preferably in range of +2 kV up to +16 kV, in order to generate photons upon impact of said electrons.

9. The method of claim 1, wherein the sample comprises an insulating material.

10. A method for imaging a sample, by detecting different types of particles emitted or backscattered from said sample, wherein the emission or scattering of said particles to be detected is caused by scanning particle beam impacting on said sample in different modes of operation, wherein a first mode of operation comprises imaging a sample as defined in claim 1; and
at least one further mode of operation comprises detecting electrons emitted from the sample upon impact of a scanning electron beam and/or a scanning ion beam and/or detecting ions emitted from the sample upon impact of a scanning ion beam.

11. The method of claim 9, wherein the sample is maintained at the same sample position during the imaging in the different imaging modes.

12. The method of claim 10, wherein at least one further mode of operation comprises detecting electrons emitted from the sample upon impact of a scanning electron beam.

13. The method of claim 10, wherein the at least one further impact of a scanning electron beam.

14. An apparatus for imaging a sample by detecting ions emitted from said sample, especially according to the method of the invention, the apparatus comprising: a scanning particle beam source for impacting on a sample for causing the emission of ions to be detected; a detector for detecting said ions, wherein said detector comprises a collector, said collector being biasable for collecting the ions; an ion to electron converter for converting the collected ions to electrons and an electron detector for detecting the converted electrons; characterized in that said particle beam source is an electron beam source; the apparatus further comprising control means arranged to control the electron beam source to provide said scanning electron beam and arranged to control the detector to detect ions.
